(19) United States
(12) Patent Application Publication
(10) Pub. No.: US 2024/0004051 A1
(43) Pub. Date: Jan. 4, 2024

(54) RADAR RANGING METHOD, RANGING RADAR, AND UNMANNED AERIAL VEHICLE THEREOF

(71) Applicant: Autel Robotics Co., Ltd., Shenzhen (CN)

(72) Inventors: Feng TAO, Shenzhen (CN); Yanfeng Dang, Shenzhen (CN)

(73) Assignee: Autel Robotics Co., Ltd., Shenzhen (CN)

(21) Appl. No.: 18/215,654

(22) Filed: Jun. 28, 2023

(30) Foreign Application Priority Data
Jul. 1, 2022 (CN) 202210775584.4

(51) Int. Cl. G01S 13/34; G01S 7/35; G01S 13/536; G05D 1/10

(52) U.S. Cl. CPC G01S 13/347; G01S 7/356; G01S 13/536; G05D 1/106

(57) ABSTRACT

A radar ranging method and a ranging radar are applied to an unmanned aerial vehicle. A first range to an obstacle is obtained using a first radar waveform. range. A second range to the obstacle are obtained using a second radar waveform if the first range is less than a preset switching threshold. the maximum detection range of the first radar waveform is greater than that of the second radar waveform; and a detection range resolution of the second radar waveform is higher than that of the first radar waveform.

### CROSS-REFERENCE TO RELATED APPLICATION

This application claims priority of Chinese Patent Application No. 202210775584.4, filed on Jul. 1, 2022 and entitled “RADAR RANGING METHOD, RANGING RADAR, AND UNMANNED AERIAL VEHICLE THEREOF,” the entire disclosure of which is incorporated herein by reference for all purposes.

### BACKGROUND

With the wide use of consumer-grade unmanned aerial vehicles in daily life, people pay more attention to issues related to the safe flight of unmanned aerial vehicles. Accurate measurement of the altitude of the unmanned aerial vehicle is the key to achieve safe flight. Commonly used altimetry sensors include GPS, barometers, ultrasonic radars, and millimeter wave radars. Millimeter wave radars have the advantages of low costs, long detection range, and high integration, and therefore have been widely used in the measurement of the altitude field of unmanned aerial vehicles.

The unmanned aerial vehicle performs obstacle avoidance and landing operations based on altitude measurement information. The specific implementation is as follows. If the millimeter wave radar detects an obstacle suddenly appearing below the unmanned aerial vehicle during a normal flight of the unmanned aerial vehicle, the millimeter wave radar can detect the range to and the speed and azimuth of the obstacle, so the unmanned aerial vehicle can control itself to move in an opposite direction to avoid the obstacle. During landing, the unmanned aerial vehicle corrects a current descent speed based on altitude information obtained by the millimeter wave radar, and executes a motor stopping command when determining that the altitude information is equal to an installation altitude of the radar. Therefore, during operation of the unmanned aerial vehicle, the detection range and detection precision of the millimeter wave radar are very important.

Existing millimeter wave radars used in the solution of measuring the altitude of unmanned aerial vehicles have the following defects. Existing millimeter wave radars cannot meet the requirements for large detection ranges and high detection precision at the same time. Usually, the altitude of the bottom of a consumer-grade unmanned aerial vehicle is at the centimeter level. If a millimeter wave radar is adopted as the only altimetry sensor, the measurement needs to be precise to at least the centimeter level. To ensure the safe flight of the unmanned aerial vehicle, the maximum detection range needs to be at least 100 meters. Therefore, how to achieve both the centimeter-level ranging accuracy and the detection range of at least 100 meters of the millimeter wave radar is an urgent problem to be resolved.

### SUMMARY

The present disclosure relates to the field of radar detection, and in particular, to a radar ranging method, a ranging radar and an unmanned aerial vehicle thereof.

According to an aspect of the present disclosure, a radar ranging method applied to a millimeter wave radar is provided. The method includes: obtaining a first range to an obstacle using a first radar waveform; determining whether the first range is less than a preset switching threshold; in response to determining that the first range is no less than the preset switching threshold, continuing to use the first radar waveform; and in response to determining that the first range is less than the preset switching threshold, obtaining a second range to the obstacle using a second radar waveform, wherein a first maximum detection range of the first radar waveform is greater than a second maximum detection range of the second radar waveform; and a second detection range resolution of the second radar waveform is higher than a first detection range resolution of the first radar waveform.

According to another aspect of the present disclosure, a ranging radar is provided, including: a synthesizer, configured to generate a continuous modulation wave signal, where the continuous modulation wave signal comprises a long-range modulation wave signal and a short-range modulation wave signal; a transmitting antenna, configured to transmit the continuous modulation wave signal; a receive antenna, configured to receive an echo signal formed by the continuous modulation wave signal reflected by an obstacle; a frequency mixer, configured to obtain an intermediate frequency signal including a range according to the continuous modulation wave signal and the echo signal; an analog-to-digital converter, configured to convert the intermediate frequency signal into a digital signal; and a digital signal processor, configured to perform the radar ranging method according to the digital signal.

According to another aspect of the present disclosure, an unmanned aerial vehicle is provided, including: a fuselage, a power supply device, a flight control system, and a ranging radar described above, where a power system for driving an unmanned aerial vehicle to fly is arranged in the fuselage; the power supply module is accommodated in the fuselage and is configured to provide power for the power system, the flight control system and the ranging radar; and the flight control system is respectively in communication connection with the ranging radar and the power system, the ranging radar provides target range to the radar, and the flight control system controls the power system according to the target range.

The present disclosure has the following beneficial effects: Different from the prior art, the present disclosure can make the millimeter wave radar switch the working state automatically according to the target detection condition, to implement the detection effect of a long-range low-resolution and a short-range high-resolution, so that the millimeter wave radar has the detection range of at least 100 meters and the centimeter-level detection precision at the same time.

### BRIEF DESCRIPTION OF THE DRAWINGS

FIG. 1 is a waveform diagram of a linear frequency modulated continuous wave signal according to some embodiments of the present disclosure;

FIG. 2 is a line graph of a frequency of a linear continuous modulation wave signal according to some embodiments of the present disclosure;

FIG. 3 is a structural diagram of a function of a ranging radar according to some embodiments of the present disclosure;

FIG. 4 is a waveform diagram of a continuous modulation wave signal and an echo signal thereof according to some embodiments of the present disclosure;

FIG. 5 is a waveform diagram of an intermediate frequency signal according to some embodiments of the present disclosure;

FIG. 6 is a schematic flowchart of a radar ranging method according to some embodiments of the present disclosure;

FIG. 7 is a schematic flowchart of another radar ranging method according to some embodiments of the present disclosure;

FIG. 8 is a schematic flowchart of a correction method according to some embodiments of the present disclosure;

FIG. 9 is a schematic flowchart of step S410 in a correction method according to some embodiments of the present disclosure;

FIG. 10 is a schematic flowchart of step S420 in a correction method according to some embodiments of the present disclosure;

FIG. 11 is a schematic flowchart of step S430 in a correction method according to some embodiments of the present disclosure;

FIG. 12 is a schematic flowchart of step S440 in a correction method according to some embodiments of the present disclosure; and

FIG. 13 is a schematic flowchart of a method of measuring the altitude of a millimeter wave radar of an unmanned aerial vehicle according to some embodiments of the present disclosure.

### DETAILED DESCRIPTION

The following describes the present disclosure in detail with reference to specific embodiments. The following embodiments will help those skilled in the art to further understand the present disclosure, but are not intended to limit the present disclosure in any form. Variations and improvements may be further made in some embodiments without departing from the concept of the present disclosure. The variations and improvements shall fall within the protection scope of the present disclosure.

To make the objectives, technical solutions, and advantages of the present disclosure clearer and more understandable, the present disclosure is further described in detail below with reference to the accompanying drawings and the embodiments. It is to be understood that the specific embodiments described herein are only used for explaining the present disclosure, and are not used for limiting the present disclosure.

A radar ranging method, a ranging radar and an unmanned aerial vehicle provided in the present disclosure are all implemented based on a basic principle of a millimeter wave radar with continuous modulation waves. Frequency modulated continuous wave (FMCW) radar is a special type of continuous wave radar. Compared with a simple continuous wave (CW) radar, a working frequency of the frequency modulated continuous wave radar is changed by frequency modulation (or phase modulation) of the transmit signal.

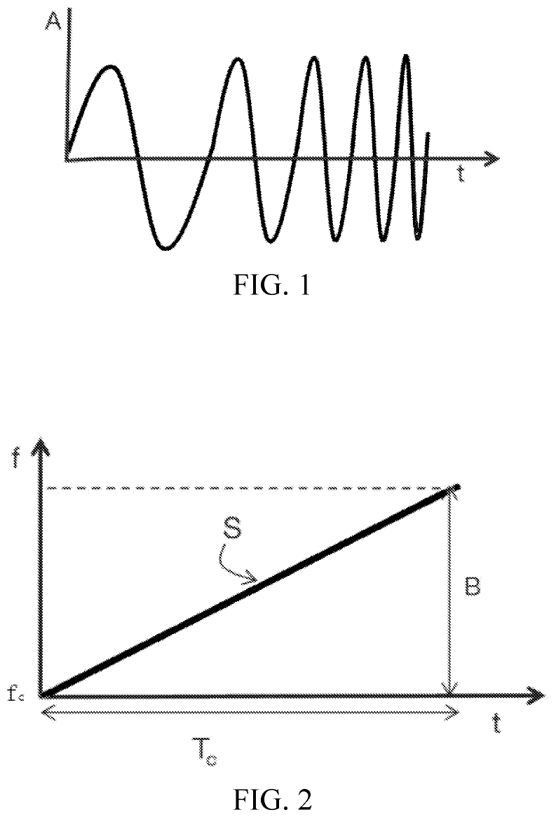

The continuous modulation wave includes a linear continuous modulation wave and a nonlinear continuous modulation wave, and the continuous modulation wave mentioned in the embodiments of the present disclosure refers to a linear continuous modulation wave unless otherwise specified. The so-called linear continuous modulation wave refers to the frequency of the used signal increases linearly with time. As shown in FIG. 1 and FIG. 2, FIG. 1 is a waveform diagram of a linear continuous modulation wave signal, a horizontal axis represents time and a vertical axis represents amplitude (amplitude of the modulation wave). FIG. 2 is a line graph of a frequency of a linear continuous modulation wave signal, a horizontal axis represents time, a vertical axis represents frequency, fc represents a start frequency, T_{c} represents duration, and B represents amplitude change within duration, that is, a bandwidth. Bandwidth herein refers to the width of an electromagnetic wave frequency band, that is, the difference between the highest frequency and the lowest frequency of a signal.

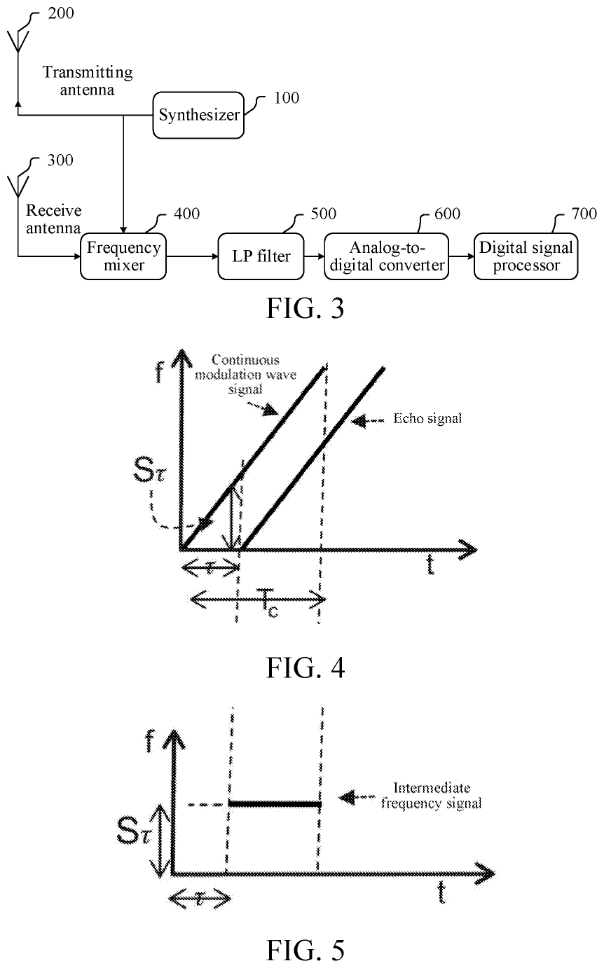

Refer to FIG. 3, FIG. 3 is a functional structural diagram of a ranging radar according to the embodiments of the present disclosure. The ranging radar includes a synthesizer 100, a transmitting antenna 200, a receive antenna 300, a frequency mixer 400, an LP filter 500, an analog-to-digital converter 600 and a digital signal processor 700.

The synthesizer 100 is respectively connected to a first input end of the transmitting antenna 200 and the frequency mixer 400, and the receive antenna 300 is connected to a second input end of the frequency mixer 400. An output end of the frequency mixer 400 is connected to an input end of the LP filter 500, an output end of the LP filter 500 is connected to an input end of the analog-to-digital converter 600, and an output end of the analog-to-digital converter 600 is connected to an input end of the digital signal processor 700.

The synthesizer 100 refers specifically to a radar frequency synthesizer, and refers to a circuit device for generating a set of output signals of a specified frequency, power, and waveform required by a radar.

The transmitting antenna 200 can be a transducer capable of converting a guided wave propagating on a transmission line into an electromagnetic wave propagating in an unbounded medium (usually free space).

The receive antenna 300 can be a transducer capable of converting an electromagnetic wave propagating in an unbounded medium (usually free space) into a guided wave propagating on a transmission line.

The frequency mixer 400 is a circuit in which the frequency of the output signal is equal to the sum, difference or other combination of the frequencies of the two input signals.

The LP filter 500 refers to a low-pass filter, and the low-pass filter is a frequency selective device that allows a low-frequency or a direct-current component of a signal to pass and suppresses a high-frequency component or interference and noise. Using the frequency selective function of the low-pass filter, interference noise may be filtered or spectrum analysis may be performed.

The analog-to-digital converter 600 usually refers to an electronic component that converts an analog signal into a digital signal. A common analog-to-digital converter converts an input voltage signal into an output digital signal.

The digital signal processor 700 is a processor that includes a large-scale or ultra-large-scale integrated circuit chip for performing a digital signal processing task. Digital signal processing is a theory and technology of representing and processing signals digitally. Digital signal processing and analog signal processing are subsets of signal processing. An objective of digital signal processing is to measure or filter a continuous analog signal in the real world.

The range estimation principle of the millimeter wave radar is as follows:

The synthesizer 100 is configured to generate a continuous modulation wave signal and transmit the continuous modulation wave signal to the transmitting antenna 200 and an input end of the frequency mixer 400, and the continuous modulation wave signal is shown in FIG. 1 and FIG. 2. The continuous modulation wave signal is transmitted from the transmitting antenna 200 to an obstacle (that is, a detection target), and then reflected by the obstacle to generate a reflected continuous modulation wave signal received by the receive antenna 300, that is, an echo signal. After receiving the echo signal, the receive antenna 300 transmits the echo signal to the other input end of the frequency mixer 400.

Therefore, after the frequency mixer 400 receives the continuous modulation wave signal, it needs a period of time before receiving the echo signal. It may be understood that the echo signal is a delayed copy of the continuous modulation wave signal. As shown in FIG. 4, τ is a time interval between the frequency mixer 400 receiving the continuous modulation wave signal and the echo signal (that is, the time taken from transmitting the continuous modulation wave signal from the transmitting antenna 200 to receiving the echo signal from the receive antenna 300), S_{τ} is an instantaneous frequency difference between the continuous modulation wave signal and the echo signal, and T_{C} is the duration of the continuous modulation wave signal.

The frequency mixer 400 obtains an intermediate frequency signal from the continuous modulation wave signal and the echo signal. As shown in FIG. 5, the intermediate frequency signal outputted by the frequency mixer 400 is obtained by subtracting the continuous modulation wave signal and the echo signal. Since the continuous modulation wave signal and the echo signal are both linear, the intermediate frequency signal is a single tone signal with a constant frequency, and the constant frequency is:

$$f = τ {S}_{τ} = \frac{2 {dS}_{τ}}{c} \qquad ( 1 )$$

d is a range between the millimeter wave radar and the obstacle, and c is the speed of light.

Therefore, the range between the millimeter wave radar and the obstacle may be estimated based on the intermediate frequency signal.

The ranging radar provided in the present disclosure has two detection waveforms, namely, the synthesizer 100 can generate continuous modulation wave signals of two waveforms, including a first radar waveform and a second radar waveform. In some embodiments, more detailed waveform switching logic may be designed according to actual requirements, and the radar may be made include more radar waveforms and the switching logic thereof, so that application of the radar is more comprehensive. The main parameters of the two waveforms are shown in the following table:

| | First radar waveform | Second radar waveform |
|---|---|---|
| Bandwidth/MHz | B₁ | B₂ |
| Chirp rise time/us | T₁₁ | T₂₁ |
| Chirp fall time/us | T₁₂ | T₂₂ |
| Chirp free time/us | T₁₃ | T₂₃ |
| Number of ADC sampling points | N₁ | N₂ |
| Chirp number | M₁ | M₂ |
| ADC sampling frequency/MHz | F₁ | F₂ |

Chirp: The transmit signal of the millimeter wave radar is a frequency modulated continuous wave, and transmitting a signal is referred to as a Chirp. The slope, rise time, and fall time of the Chirp are related to radar performance.

The first radar waveform is a long-range modulation wave signal, and the second radar waveform is a short-range modulation wave signal. The difference between the long-range modulation wave signal and the short-range modulation wave signal lies in the difference between the maximum detection range and the range resolution.

The range resolution is the capability of the radar to distinguish two or more objects in a range dimension. When the range between the two objects and the radar is close to a certain value, the radar can no longer distinguish the two objects and the radar, and distinguish the two objects and the radar into a same object.

The range resolution of the millimeter wave radar Rᵣₑₛ is related to an effective bandwidth Bₑ, and a relationship between the two satisfies:

$${R}_{res} = \frac{c}{2 {B}_{e}} \qquad ( 2 )$$

Due to inherent defects of a millimeter wave radar transmitter, a linear effect of the transmitted frequency modulated continuous wave signal is poor in an initial period of time, which cannot be used. Therefore, the sampling time of ADC usually lags behind for a period of time, the spectrum occupied by the sampling time of ADC in actual application is referred to as “an effective bandwidth”. The effective bandwidth Bₑ is equal to the ratio of sampling time to rise time multiplied by the bandwidth, that is,

$${B}_{e} = \frac{N / F}{{T}_{up}} * B \qquad ( 3 )$$

T_{w} is the rise time, N represents a quantity of points of a Fast Fourier Transform in a range dimension, F represents the sampling frequency of analog-to-digital conversion, and N/F is the sampling time.

Fast Fourier Transform (Fast Fourier Transform, FFT) refers to that a function satisfying certain conditions is represented as a trigonometric function (a sine and/or cosine function) or a linear combination of their integrals.

Sampling is to convert a signal (that is, a continuous function in time or space) into a numerical sequence (that is, a discrete function in time or space).

The maximum detection range is the maximum range that the radar may observe when considering the effects of earth curvature, antenna height, object height and atmospheric refraction in radar radio wave propagation space. The maximum detection range R_{maX} is proportional to the range resolution Rᵣₑₛ, that is,

Rₘₐₓ=Rᵣₑₛ*N (4)

When the analog-to-digital conversion sampling is real sampling, the quantity of points of the FFT in the range dimension is half of the quantity of points in the analog-to-digital conversion sampling. When the analog-to-digital conversion sample is plural sampling, the quantity of points of the FFT in the range dimension is equal to the quantity of points in the analog-to-digital conversion sampling. As seen from the foregoing formulas, the range resolution Rᵣₑₛ may be controlled by adjusting the size of the effective bandwidth Bₑ. The maximum detection range Rₘₐₓ may be controlled by adjusting Rᵣₑₛ and N.

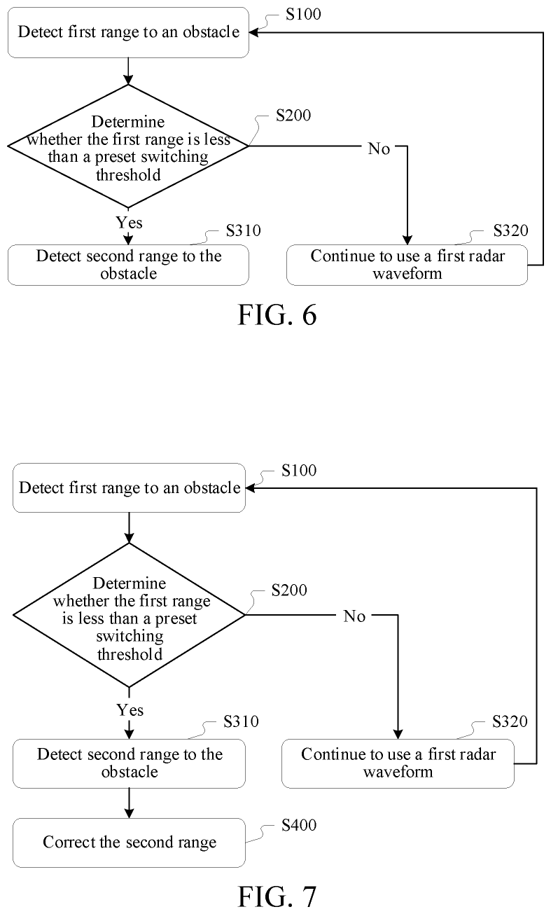

Based on the ranging radar, the embodiments of the present disclosure provide a radar ranging method. FIG. 6 is a schematic flowchart of the ranging method, and the method includes the following steps.

Step S100: Detect first range to an obstacle.

Specifically, the ranging radar uses a first radar waveform according to a preset setting, that is, transmits a long-range modulation wave signal to an obstacle, and obtains the first range between the ranging radar and the obstacle after receiving a long-range echo signal.

Step S200: Determine whether the first range is less than a preset switching threshold.

After obtaining the first range to the obstacle, it is determined whether the first range is less than a preset switching threshold. If the first range is less than the preset switching threshold, step S310 is performed; and if the first range is not less than the preset switching threshold, step S320 is performed.

In some embodiment, the preset switching threshold is equal to the maximum detection range of the second radar waveform, that is, the maximum detection range is that the ranging radar uses the short-range continuous modulation wave signal for detection.

Step S310: Detect second range to the obstacle.

It can be learned from the foregoing step S200, if the first range is less than the maximum detection range of the second radar waveform, the ranging radar switches to use the second radar waveform, that is, transmits a short-range modulation wave signal to the obstacle, and obtains the second range between the ranging radar and the obstacle after receiving the short-range echo signal.

In some embodiments, the maximum detection range of the first radar waveform is greater than the maximum detection range of the second radar waveform; and a detection range resolution of the second radar waveform is higher than a detection range resolution of the first radar waveform.

Step S320: Continue to use the first radar waveform.

If the first range is not less than the maximum detection range of the second radar waveform, the ranging radar continuously obtains the first range by continuing to use the first radar waveform.

In some embodiments, in order to obtain accurate range, the obtained short-range range (that is, the second range) also needs to be corrected. As shown in FIG. 7, the specific steps are as follows.

Step S100: Detect first range to an obstacle.

Specifically, the ranging radar uses a first radar waveform according to a preset setting, that is, transmits a long-range modulation wave signal to an obstacle, and obtains the first range between the ranging radar and the obstacle after receiving a long-range echo signal.

Step S200: Determine whether the first range is less than a preset switching threshold.

After obtaining the first range to the obstacle, it is determined whether the first range is less than the preset switching threshold. If the first range is less than the preset switching threshold, step S310 is performed; and if the first range is not less than the preset switching threshold, step S320 is performed.

It should be noted that, in this embodiment, the preset switching threshold is equal to the maximum detection range of the second radar waveform, that is, the maximum detection range is that the ranging radar uses the short-range continuous modulation wave signal for detection.

Step S310: Detect second range to the obstacle.

It can be learned from the foregoing step S200, if the first range is less than the maximum detection range of the second radar waveform, the ranging radar switches to use the second radar waveform, that is, transmits a short-range modulation wave signal to the obstacle, and obtains the second range between the ranging radar and the obstacle after receiving the short-range echo signal.

In some embodiments, the maximum detection range of the first radar waveform is greater than that of the second radar waveform; and a detection range resolution of the second radar waveform is higher than that of the first radar waveform.

Step S320: Continue to use the first radar waveform.

If the first range is not less than the maximum detection range of the second radar waveform, the ranging radar continuously obtains the first range by continuing to use the first radar waveform. Step S400: Correct the second range.

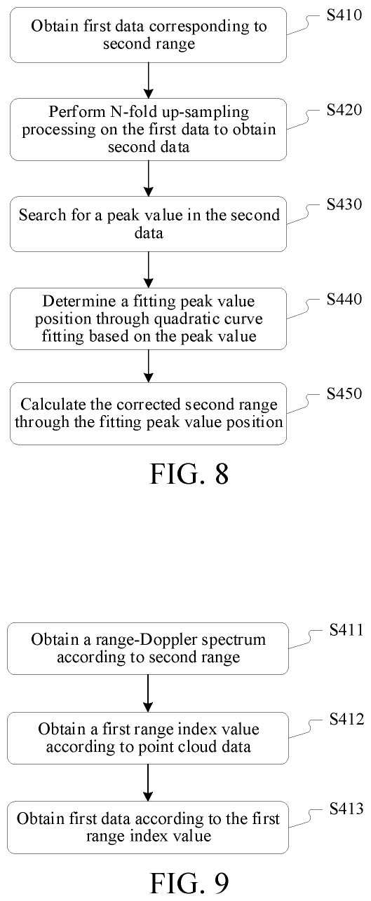

After obtaining the second range, in order to obtain more accurate range, the second range needs to be corrected. During correction, more accurate fitting peak value position is obtained by up-sampling, to obtain more accurate range, thereby implementing centimeter-level detection precision. The specific implementing steps as shown in FIG. 8, the correction method shown in FIG. 8 includes the following steps.

Step S410: Obtain first data corresponding to the second range.

Specifically, obtaining first data corresponding to the second range includes the following steps, as shown in FIG. 9.

Step S411: Obtain a range-Doppler spectrum through an FFT according to the second range.

The range-Doppler spectrum is obtained from the obtained second range through the FFT of the range dimension and the FFT of the Doppler dimension.

Step S412: Obtain a first range index value according to point cloud data.

A range index value in the point cloud data corresponding to the second range is extracted to obtain the first range index value.

Step S413: Obtain the first data according to the first range index value.

Based on the first range index value obtained in step S412, corresponding data is obtained in the range-Doppler spectrum obtained in step S411, and the extracted data is as follows:

X(i,k),i=1,2L M,k=1,2L2*range_idx (5)

range_idx is the first range index value, and M is the number of virtual antennas.

The data of the M virtual antennas are superimposed to obtain the first data, as shown in the following formula:

$$X ( k ) = {\sum }_{i = 1}^{M} X ( i , k ) , k = 1 , 2 L 2 * range\_idx \qquad ( 6 )$$

Step S420: Perform N-fold up-sampling processing on the first data to obtain second data.

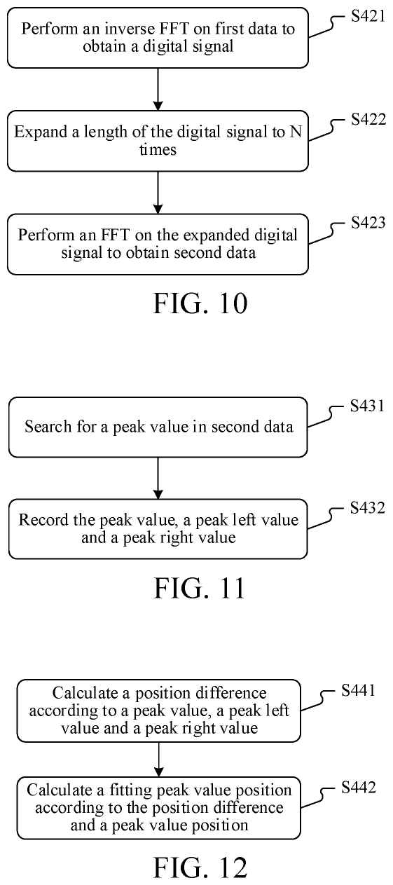

Specifically, performing N-fold up-sampling processing on the first data to obtain second data includes the following steps, as shown in FIG. 10.

Step S421: Perform an inverse FFT on the first data to obtain a digital signal.

In this embodiment, an example in which the first data is performed 2 times up-sampling. The first data obtained in step S410 is performed an inverse FFT to obtain a digital signal, as shown in the following formula:

$$y ( n ) = \frac{1}{N} {\sum }_{n = 0}^{N - 1} X ( k ) {e}^{- j ( 2 π / N ) kn} \qquad ( 7 )$$

Step S422: Expand a length of the digital signal to N times.

The length of the digital signal is expanded by adding zero at an end of the digital signal. In step S421, for example, the first data is performed 2 times up-sampling, so that the expanded digital signal is y (2n).

Step S423: Perform an FFT on the N-fold expanded digital signal to obtain the second data.

Then, the expanded digital signal is performed fast Fourier transformation to obtain second data, and the second data is shown in the following formula:

$$Y ( 2 N ) = {\sum }_{n = 0}^{2 N - 1} y ( n ) {e}^{- j ( 2 π / N ) kn} \qquad ( 8 )$$

Step S430: Search for a peak value in the second data.

Specifically, searching for a peak value in the second data includes the following steps, as shown in FIG. 11.

S431: Search for the peak value in the second data.

Specifically, it can be learned from the foregoing steps, the length of the second data has been expanded by 2 times compared with the length of the first data, and corresponding peak value position may also be offset. Originally, in the first data, the peak value position was at a position of the first range index value range_idx. In the second data, the nearest peak value should be searched for near the second range index value, that is, 2*range_idx. Search for the nearest peak value, which is recorded as x(0)=β. Record that the peak value position at this time is k.

S432: Record the peak value, a peak left value and a peak right value.

After searching for and recording the nearest peak value, the first value around the nearest peak value is recorded. The first value on the right is recorded as the peak right value x(−1)=α, and the first value on the left is recorded as the peak left value x(1)=γ.

Step S440: Determine a fitting peak value position through quadratic curve fitting based on the peak value.

Specifically, determining a fitting peak value position through quadratic curve fitting based on the peak value includes the following steps, as shown in FIG. 12.

Step S441: Calculate a position difference according to the peak value, the peak left value and the peak right value.

From the peak value, the peak left value and the peak right value are obtained in step S432, and the position difference is calculated according to the following formula:

$$Δ = \frac{1}{2} \frac{α - γ}{a - 2 β + γ} \qquad ( 9 )$$

It should be noted that, a value of 0 ranges from −½ to ½.

Step S442: Calculate the fitting peak value position according to the position difference and the peak value position.

From the position difference obtained in step S441 and the peak value position obtained in step S431, the fitting peak value position is calculated according to the following formula:

kᵣₑₐₗ=k+Δ (10)

Step S450: Calculate the corrected second range through the fitting peak value position.

Based on the fitting peak value position, the corrected second range, that is, a more accurate target range, is calculated. Since 2-fold up-sampling is performed, the formula for calculating the corrected second range is as follows:

Rᵣₑₐₗ=kᵣₑₐₗ/N*Rᵣₑₛ (11)

Rᵣₑₛ is the range resolution under the second radar waveform.

According to the foregoing formula (2) and formula (3), the range resolution Rᵣₑₛ may be calculated, so that the corrected second range may be calculated.

Different from the prior art, the present disclosure can make the millimeter wave radar switch a working state automatically according to a target detection situation, to implement the detection effect of a long-range low resolution and a short-range high resolution, so that the millimeter wave radar has the detection range of at least 100 meters and the centimeter-level detection precision at the same time.

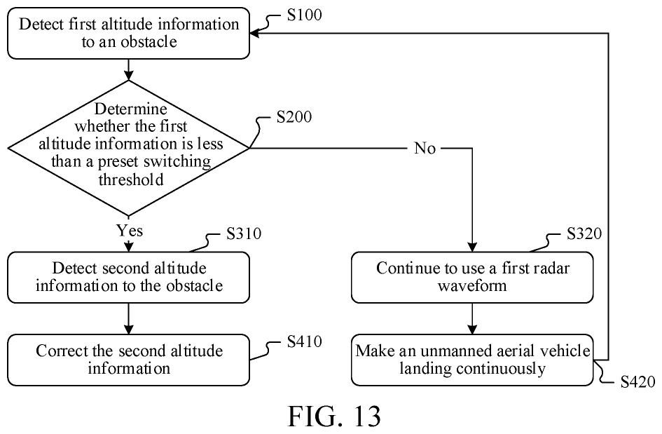

When the ranging radar capable of performing the radar ranging method is applied to the unmanned aerial vehicle, the unmanned aerial vehicle may be enabled to perform a method of measuring the altitude of the millimeter wave radar of the unmanned aerial vehicle. As shown in FIG. 13, the method includes the following steps.

Step S100: Detect first altitude information to an obstacle.

The ranging radar uses a first radar waveform according to the preset setting, that is, transmits a long-range modulation wave signal to an obstacle (that is, the ground), and obtains the first altitude information between the ranging radar and the obstacle after receiving a long-range echo signal.

Step S200: Determine whether the first altitude information is less than a preset switching threshold.

After obtaining the first altitude information to the obstacle, it is determined whether the first altitude information is less than the preset switching threshold. If the first altitude information is less than the preset switching threshold, step S310 is performed; and if the first altitude information is not less than the preset switching threshold, step S320 is performed.

It should be noted that, in this embodiment, the preset switching threshold is equal to the maximum detection range of the second radar waveform, that is, the maximum detection range is that the ranging radar uses the short-range continuous modulation wave signal for detection.

Step S310: Detect second altitude information to an obstacle.

It can be learned from the foregoing step S200, if the first altitude information is less than the maximum detection range of the second radar waveform, the ranging radar switches to use the second radar waveform. That is, the ranging radar transmits a short-range modulation wave signal to the obstacle, and obtains the second altitude information between the ranging radar and the obstacle after receiving the short-range echo signal. Then, step S410 is performed.

It should be noted that, the maximum detection range of the first radar waveform is greater than the maximum detection range of the second radar waveform; and a detection range resolution of the second radar waveform is higher than the detection range resolution of the first radar waveform.

Step S320: Continue to use the first radar waveform.

If the first altitude information is not less than the maximum detection range of the second radar waveform, the ranging radar continuously obtains the first altitude information by continuing to use the first radar waveform. Then, step S420 is performed.

Step S420: Make the unmanned aerial vehicle landing continuously.

When the first altitude information is not less than the maximum detection range of the second radar waveform, the ranging radar needs to continue to use the first radar waveform to make the unmanned aerial vehicle landing continuously, and continuously obtains the first altitude information between the unmanned aerial vehicle and the obstacle during continuous landing of the unmanned aerial vehicle.

Step S400: Correct the second altitude information.

After obtaining the second altitude information, in order to obtain more accurate altitude information, the second altitude information needs to be corrected. Specific implementation steps are shown in FIG. 7, and details are not described herein again.

Different from the prior art, the present disclosure can be applied to the unmanned aerial vehicle to report a distant target to the unmanned aerial vehicle in time when the unmanned aerial vehicle normally flies and avoids the obstacle, thereby leaving enough reaction time for the unmanned aerial vehicle to ensure safe flight. The present disclosure can also be applied to report an accurate fuselage altitude to the UAV when the unmanned aerial vehicle lands, so as to help the unmanned aerial vehicle control the descent speed and make the unmanned aerial vehicle landing safer.

The foregoing descriptions are merely implementations of the present disclosure, and the patent scope of the present disclosure is not limited thereto. All equivalent structure or process changes made according to the content of this specification and accompanying drawings in the present disclosure by directly or indirectly applying the present disclosure in other related technical fields shall fall within the protection scope of the present disclosure.

What is claimed is:

1. A radar ranging method, applied to a millimeter wave radar, the method comprising:
Obtaining a first range to an obstacle using a first radar waveform;
determining whether the first range is less than a preset switching threshold;
in response to determining that the first range is no less than the preset switching threshold, continuing to use the first radar waveform; and
in response to determining that the first range is less than the preset switching threshold, obtaining a second range to the obstacle using a second radar waveform,
wherein a first maximum detection range of the first radar waveform is greater than a second maximum detection range of the second radar waveform; and a second detection range resolution of the second radar waveform is higher than a first detection range resolution of the first radar waveform.

2. The method according to claim 1, further comprising:
correcting the second range.

3. The method according to claim 2, wherein the correcting the second range comprises:
obtaining first data corresponding to the second range;
performing N-fold up-sampling processing on the first data to obtain second data;
searching for a peak value in the second data;
determining a fitting peak value position through quadratic curve fitting based on the peak value; and
calculating the corrected second range based on the fitting peak value position.

4. The method according to claim 3, wherein the obtaining first data corresponding to the second range comprises:
obtaining a range-Doppler spectrum through a Fast Fourier Transform (FFT) according to the second range;
obtaining a first range index value according to point cloud data corresponding to the second range; and
obtaining the first data from the range-Doppler spectrum according to the first range index value.

5. The method according to claim 4, wherein the obtaining the first data from the range-Doppler spectrum according to the first range index value comprises:
obtaining corresponding data of a single virtual antenna from the range-Doppler spectrum according to the first range index value; and
obtaining the first data through superimposing the corresponding data of M virtual antennas, M being a number of the virtual antennas.

6. The method according to claim 5, wherein the performing N-fold up-sampling processing on the first data to obtain second data comprises:
performing an inverse FFT on the first data to obtain a digital signal;
expanding a length of the digital signal by N-fold; and
performing the FFT on the digital signal expanded by N-fold to obtain the second data.

7. The method according to claim 6, wherein the searching for a peak value in the second data comprises:
searching for a nearest peak value according to a second range index value in the second data; and
recording the peak value as the nearest peak value, and recording a peak left value and a peak right value,
wherein the second range index value is N times the first range index value, the peak left value is a first value on the left of the peak value, and the peak right value is a first value on the right of the peak value.

8. The method according to claim 7, wherein the determining a fitting peak value position through quadratic curve fitting based on the peak value comprises:
calculating a position difference according to the peak value, the peak left value, and the peak right value; and
calculating the fitting peak value position according to the position difference and a peak value position.

9. The method according to claim 8, wherein the position difference is calculated according to the following formula:
$$Δ = \frac{1}{2} \frac{α - γ}{2 α - 2 β + γ} ,$$
wherein
Δ is the position difference, α is the peak right value, β is the peak value and γ is the peak left value.

10. The method according to claim 9, wherein the fitting peak value position is calculated according to the following formula:
kᵣₑₐₗ=k+Δ, wherein
k is the peak value position and kᵣₑₐₗ is the fitting peak value position.

11. The method according to claim 10, wherein the calculating the corrected second range through the fitting peak value position comprises:
the corrected second range is calculated through the fitting peak value position according to the following formula:
Rᵣₑₐₗ=kᵣₑₐₗ/N*Rᵣₑₛ, wherein
Rᵣₑₐᵢ is the corrected second range, Rᵣₑₛ is a range resolution in a short-range waveform detection mode, and N is an up-sampling factor.

12. The method according to claim 1, wherein the preset switching threshold is the second maximum detection range of the second radar waveform.

13. A ranging radar, comprising:
a synthesizer, configured to generate a continuous modulation wave signal, wherein the continuous modulation wave signal comprises a long-range modulation wave signal and a short-range modulation wave signal;
a transmitting antenna, configured to transmit the continuous modulation wave signal;
a receive antenna, configured to receive an echo signal formed by the continuous modulation wave signal reflected by an obstacle;
a frequency mixer, configured to obtain an intermediate frequency signal comprising a range according to the continuous modulation wave signal and the echo signal;
an analog-to-digital converter, configured to convert the intermediate frequency signal into a digital signal; and
a digital signal processor, configured to perform a plurality of operations according to the digital signal, the plurality of operations comprising:
obtaining a first range to an obstacle using a first radar waveform;
determining whether the first range is less than a preset switching threshold;
in response to determining that the first range is no less than the preset switching threshold, continuing to use the first radar waveform; and
in response to determining that the first range is less than the preset switching threshold, obtaining a second range to the obstacle using a second radar waveform,
wherein a first maximum detection range of the first radar waveform is greater than a second maximum detection range of the second radar waveform; and a second detection range resolution of the second radar waveform is higher than a first detection range resolution of the first radar waveform.

14. The ranging radar according to claim 13, wherein the digital signal processor is further configured to:
obtain first data corresponding to the second range;
perform N-fold up-sampling processing on the first data to obtain second data;
search for a peak value in the second data;
determine a fitting peak value position through quadratic curve fitting based on the peak value; and
calculate the corrected second range based on the fitting peak value position.

15. The ranging radar according to claim 14, wherein the digital signal processor is further configured to:
obtain a range-Doppler spectrum through a Fast Fourier Transform (FFT) according to the second range;
obtain a first range index value according to point cloud data corresponding to the second range; and
obtain the first data from the range-Doppler spectrum according to the first range index value.

16. The ranging radar according to claim 15, wherein the digital signal processor is further configured to:
obtain corresponding data of a single virtual antenna from the range-Doppler spectrum according to the first range index value; and
obtain the first data through superimposing the corresponding data of M virtual antennas, M being a number of the virtual antennas.

17. The ranging radar according to claim 16, wherein the digital signal processor is further configured to:
performing an inverse FFT on the first data to obtain a digital signal;
expanding a length of the digital signal by N-fold; and
performing the FFT on the digital signal expanded by N-fold to obtain the second data.

18. The ranging radar according to claim 17, wherein the digital signal processor is further configured to:
searching for a nearest peak value according to a second range index value in the second data; and
recording the peak value as the nearest peak value, and recording a peak left value and a peak right value,
wherein the second range index value is N times the first range index value, the peak left value is a first value on the left of the peak value, and the peak right value is a first value on the right of the peak value.

19. The ranging radar according to claim 18, wherein the digital signal processor is further configured to:
calculate a position difference according to the peak value, the peak left value and the peak right value; and
calculate the fitting peak value position according to the position difference and a peak value position.

20. An unmanned aerial vehicle, comprising:
a fuselage, a power supply device, a flight control system, and a ranging radar,
wherein a power system for driving an unmanned aerial vehicle to fly is arranged in the fuselage;
the power supply module is accommodated in the fuselage and is configured to provide power for the power system, the flight control system and the ranging radar;
the flight control system is respectively in communication connection with the ranging radar and the power system, the ranging radar provides target range to the radar, and the flight control system controls the power system according to the target range; and
the ranging radar comprises:
a synthesizer, configured to generate a continuous modulation wave signal, wherein the continuous modulation wave signal comprises a long-range modulation wave signal and a short-range modulation wave signal;
a transmitting antenna, configured to transmit the continuous modulation wave signal;
a receive antenna, configured to receive an echo signal formed by the continuous modulation wave signal reflected by an obstacle;
a frequency mixer, configured to obtain an intermediate frequency signal comprising a range according to the continuous modulation wave signal and the echo signal;
an analog-to-digital converter, configured to convert the intermediate frequency signal into a digital signal; and
a digital signal processor, configured to perform a plurality of operations according to the digital signal, the plurality of operations comprising:
obtaining a first range to an obstacle using a first radar waveform;
determining whether the first range is less than a preset switching threshold;
in response to determining that the first range is no less than the preset switching threshold, continuing to use the first radar waveform; and
in response to determining that the first range is less than the preset switching threshold, obtaining a second range to the obstacle using a second radar waveform,
wherein a first maximum detection range of the first radar waveform is greater than a second maximum detection range of the second radar waveform; and a second detection range resolution of the second radar waveform is higher than a first detection range resolution of the first radar waveform.
